(19) United States
(12) Patent Application Publication
(10) Pub. No.: US 2013/0091163 A1
(43) Pub. Date: Apr. 11, 2013

(54) DISCOVERING AND CONSUMING RELATED DATA

(71) Applicants: Anthony Nino Bice, Seattle, WA (US); James Finnigan, Redmond, WA (US); Levon Esibov, Redmond, WA (US)

(72) Inventors: Anthony Nino Bice, Seattle, WA (US); James Finnigan, Redmond, WA (US); Levon Esibov, Redmond, WA (US)

(73) Assignee: Microsoft Corporation, Redmond, WA (US)

(21) Appl. No.: 13/331,991

(22) Filed: Dec. 20, 2011

Related U.S. Application Data
(60) Provisional application No. 61/545,882, filed on Oct. 11, 2011.

(51) Int. Cl. G06F 17/30

(52) U.S. Cl. 707/769; 707/E17.014

(57) ABSTRACT

The present invention extends to methods, systems, and computer program products for discovering and consuming related data. Users can find data related/relevant to an accessed dataset without leaving the context of their application. A service analyzes and understands (classifies) the dataset as well as user profile information and environmental information (e.g., operating system in use, task being performed, etc.). The service displays recommendations for related/relevant data and/or related/relevant data services within the application (e.g., within a spreadsheet, database, file system, etc.). In response to user selection of a recommendation, related/relevant data (either directly or from a data service) is transferred into the application. Accordingly, relevant/related data can be transferred into an application without a user having to leave the application to search for the data.

### CROSS-REFERENCE TO RELATED APPLICATIONS

The present application claims the benefit of U.S. Provisional Patent Application Ser. No. 61/545,882, entitled “DISCOVERING AND CONSUMING RELATED DATA”, filed Oct. 11, 2011, which is incorporated by reference herein in its entirety.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing environments.

When a user is working with a dataset, the user is typically required to go and data and/or data resources that might add value to the dataset. Finding data and/or data resources, is a typically manual and somewhat burdensome process for a user.

For example, when working with a dataset, a user typically leaves their data application (e.g., word processor, spreadsheet, database, etc.) and uses search tools (e.g., Web based search engines) to find related data and/or data resources they can bring into their dataset to add value. Using a search tool also typically requires the user to provide relevant input to the search tool to cause the search tool to look for related data and/or data resources. Further, search tools typically lack any information about the user (e.g., user context) that might be used to improve searches for relevant data and/or data resources.

### BRIEF SUMMARY

The present invention extends to methods, systems, and computer program products for discovering and consuming related data. A data processing application detects that a user has accessed a dataset within the data processing application as part of performing a specified task. Subsequent to detecting the dataset has been accessed, and automatically and without user intervention, a background analysis module recommends data to extend the value of the accessed dataset.

One or more of: the accessed dataset, profile information for the user, the specified task, and historical data relevant to the accessed dataset are analyzed to identify semantics for locating further data relevant to the accessed dataset. Further relevant data and/or data services are located (e.g., from data directories) based on the identified semantics. A recommendation is presented for each further relevant data and/or data service at a display device. Each recommendation indicates how the further relevant data and/or a data service is relevant to the identified semantics.

A user selection of a recommendation presented at the display device is received. The background analysis module transfers the further relevant data and/or data from a data service into the data processing application for use within the data processing application. Transferred data corresponds to the selected recommendation.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates discovering and consuming related data.

FIG. 2 illustrates a flow chart of an example method for discovering and consuming related data.

FIGS. 3A-3C illustrate another example of discovering and consuming related data.

### DETAILED DESCRIPTION

The present invention extends to methods, systems, and computer program products for discovering and consuming related data. A data processing application detects that a user has accessed a dataset within the data processing application as part of performing a specified task. Subsequent to detecting the dataset has been accessed, and automatically and without user intervention, a background analysis module recommends data to extend the value of the accessed dataset.

One or more of: the accessed dataset, profile information for the user, the specified task, and historical data relevant to the accessed dataset are analyzed to identify semantics for locating further data relevant to the accessed dataset. Further relevant data and/or data services are located (e.g., from data directories) based on the identified semantics. A recommendation is presented for each further relevant data and/or data service at a display device. Each recommendation indicates how the further relevant data and/or a data service is relevant to the identified semantics.

A user selection of a recommendation presented at the display device is received. The background analysis module transfers the further relevant data and/or data from a data service into the data processing application for use within the data processing application. Transferred data corresponds to the selected recommendation.

Embodiments of the present invention may comprise or utilize a special purpose or general-purpose computer including computer hardware, such as, for example, one or more processors, system memory, and a display device, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The invention permits users to find data related/relevant to an accessed dataset without leaving the context of their application. A service analyzes and understands (classifies) the dataset as well as user profile information and environmental information (e.g., operating system in use, task being performed, etc.). The service displays recommendations for related/relevant data and/or related/relevant data services within the application (e.g., within a spreadsheet, database, file system, etc.). In response to user selection of a recommendation, related/relevant data (either directly or from a data service) is transferred into the application. Accordingly, relevant/related data can be transferred into an application without a user having to leave the application to search for the data.

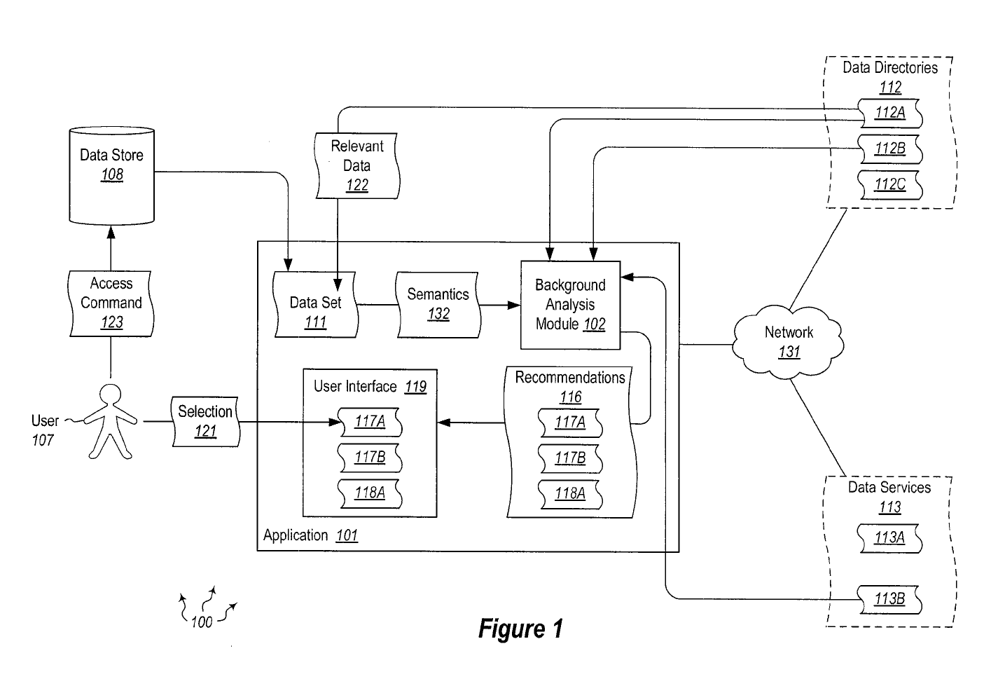

FIG. 1 illustrates an example computer architecture 100 that facilitates discovering and consuming related data. Referring to FIG. 1, computer architecture 100 includes data store 108, application 101, data directories 112, and data services 113. Each of the depicted components is connected to one another over (or is part of) a network, such as, for example, a Local Area Network (“LAN”), a Wide Area Network (“WAN”), and even the Internet, such as, for example network 131. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Application 101 includes background analysis module 102 and user interface 119. Application 101 can be virtually any data processing application such as, for example, a spreadsheet application, a database application, a word processor, etc. User 107 can interact with user interface 119 to submit input to application 101 and observe output from application 101. User 107 can interact with user interface 119 to load datasets into application 101 and manipulate data contained in datasets loaded into application 101.

Data directories 112 and data services 113 can be internal or external to an organization (e.g., corporation) user 107 is associated with.

Background analysis module 102 is configured to connect to and analyze data loaded into application 101. Background analysis module 102 operates as a background process and thus has little, if any, performance impact on other processing at application 101. Background analysis module 102 can analyze accessed data and present recommendations for further relevant data at user interface 119. The recommendations can indication how they are relevant in view of an accessed data set. For example,
“[Data Provider Name] is relevant to because the accessed data includes zip code data and this data can help you extend your understanding of addresses contained within this sheet” OR
“[Data Provider] is being recommended because there is product information in your table and this data helps you obtain details about these products” OR
[User you collaborate with] has a spreadsheet that contains information that is highly relevant to yours based on our understanding of the subject area—you should consider collaborating or if available to you, look at their dataset

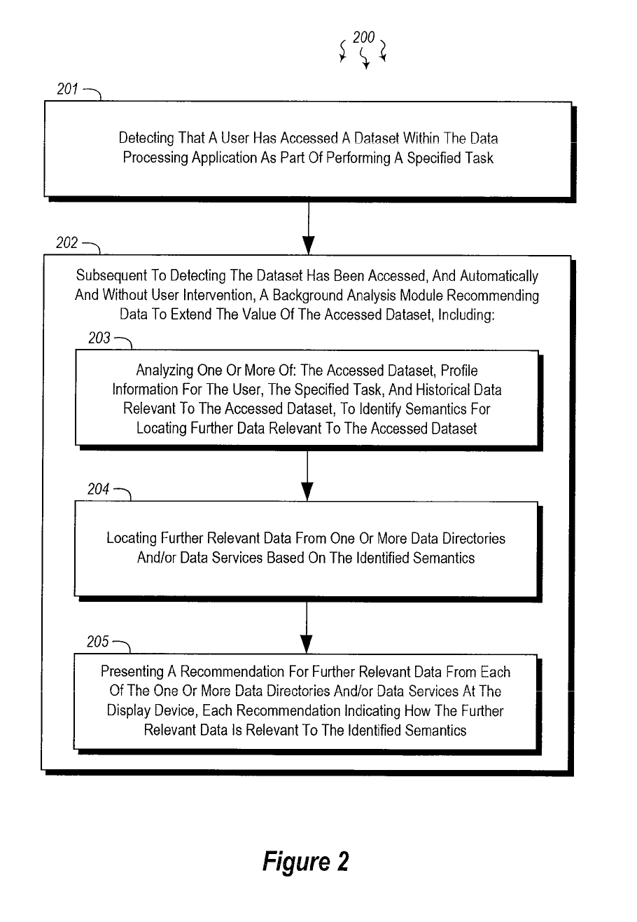

FIG. 2 illustrates a flow chart of an example method 200 for discovering and consuming related data. Method 200 will be described with respect to the components and data of computer architecture 100.

Method 200 includes an act of detecting that a user has accessed a dataset within the data processing application as part of performing a specified task (act 201). For example, application 101 can detect that user 107 has accessed data set 111 within application 101 as part of a task (e.g., adding data to a customer or product spreadsheet). User 107 can send access command 123 (possibly through user interface 119) to data store 108 to load data 111 in application 101.

Subsequent to detecting the dataset has been accessed, and automatically and without user intervention, an act of a background analysis module recommending data to extend the value of the accessed dataset (act 202). For example, subsequent to detecting that data set 111 has been accessed, background analysis module 102 can recommend data to extend the value of data set 111. Background analysis module 102 can analyze data set 111 automatically and in the background, thereby limiting any performance impact on user 107's interaction with data set 111.

Act 202 includes an act of analyzing one or more of: the accessed dataset, profile information for the user, the specified task, and historical data relevant to the accessed dataset, to identify semantics for locating further data relevant to the accessed dataset (act 203). For example, background analysis module 102 can analyze one or more of: data set 111, profile information for user 107, the task being performed on data set 111, and other historical (e.g., similar) data relevant to data set 111. From the analysis, background analysis module 102 can identify semantics 132 (e.g., nouns) for locating further data relevant data set 111.

Act 202 includes an act of locating further relevant data from one or more data directories and/or data services based on the identified semantics (act 204). For example, background analysis module 102 can identify data directories 112A and 112B and data service 113B based on semantics 132. Act 202 includes an act of presenting a recommendation for further relevant data from each of the one or more data directories and/or data services at the display device, each recommendation indicating how the further relevant data is relevant to the identified semantics (act 205). For example, background analysis module 102 can present recommendations 116 at a display device. Recommendations 116 include recommendations 117A, 117B, and 118B for data directories 112A, 112B, and data service 113B respectively at user interface 119. Each recommendation can indicate how the data directory and/or data service is relevant (e.g., by topic, subject matter, of specified interest to the user, extends understand of current data set, etc.) to data set 111. Recommendations 116 can also indicate relevancy to identified semantics based on topic.

User 107 can subsequently select one or more recommendations presented at user interface 119. For example, user 107 can submit selection 121 to user interface 119 to select recommendation 117A. User interface 119 can receive selection 121. In response to the selection of recommendation 117A, background analysis module 102 can transfer relevant data 122 from data directory 112A into data set 111. Accordingly, relevant data 1122 can be used within application 101 without user 107 have to leave application 101.

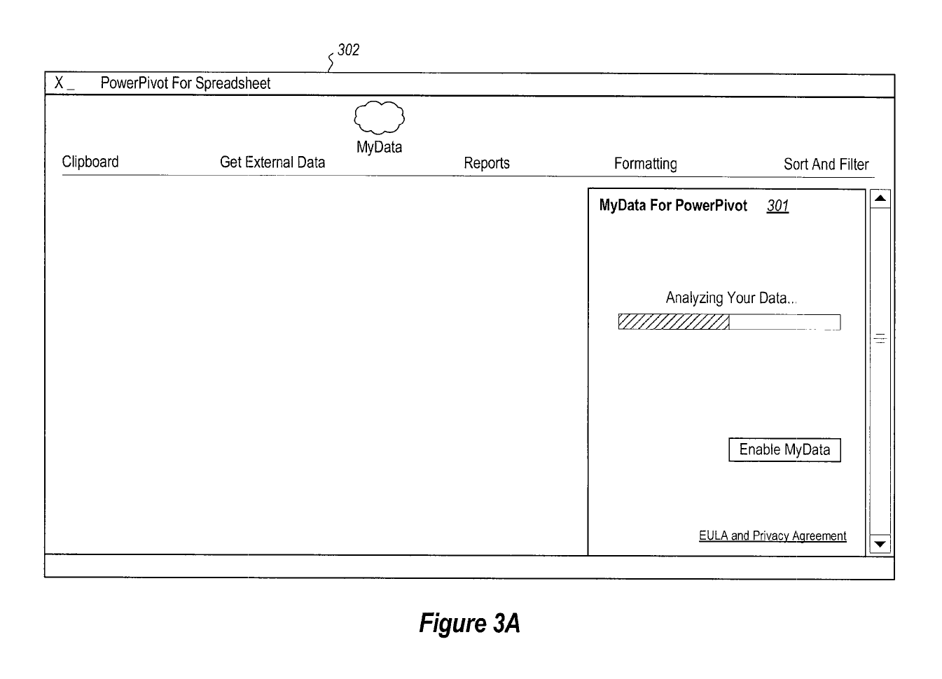

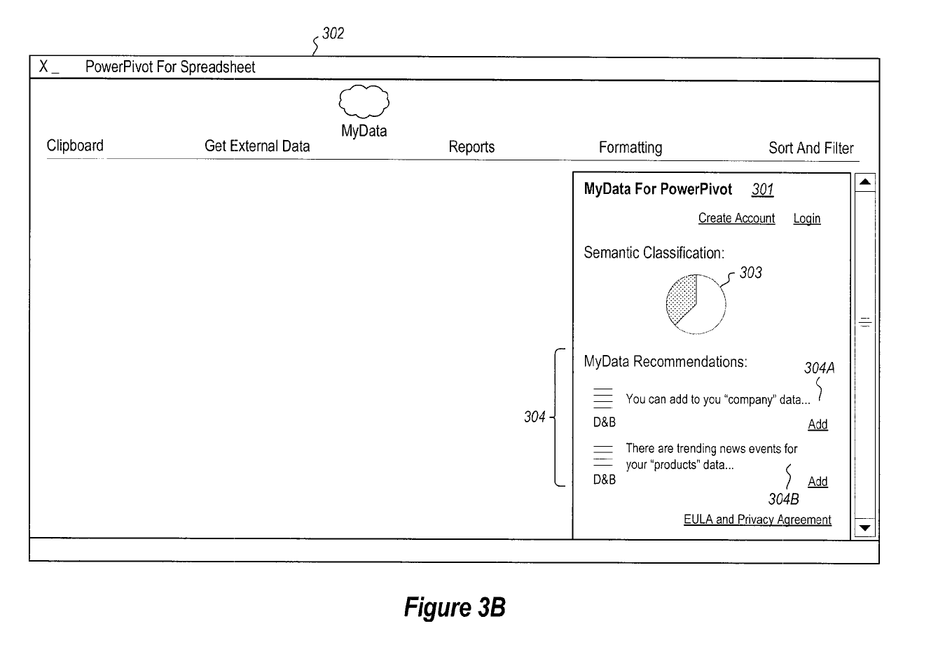

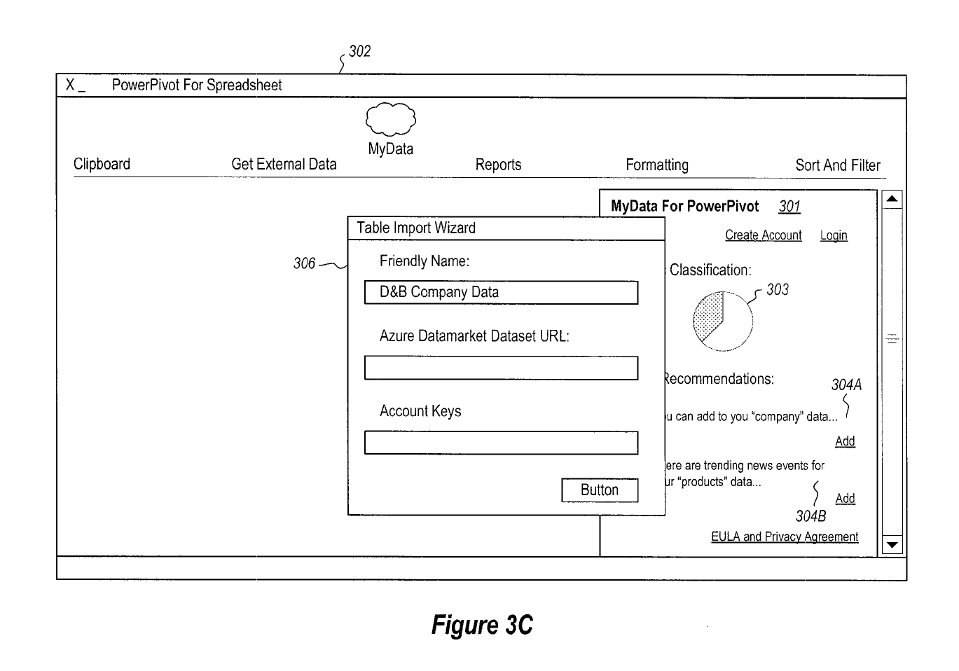

FIGS. 3A-3C illustrate another example of discovering and consuming related data. As depicted in FIG. 3A, MyData for PowerPivot 301 analyzes data within PowerPivot for spreadsheet 302. As depicted in FIG. 3B, MyData for PowerPivot 301 generates semantic classification 303 and presents recommendations 304 (for data related to the data analyzed within PowerPivot for spreadsheet 302. Recommendations 304 include recommendations 304A and 304B.

As depicted in FIG. 3C, a user has selected recommendations 304A, bringing up table import wizard 306. Table import wizard 306 can insure that data imported from the data source behind recommendation 304A is appropriately imported (e.g., formatted for use) into PowerPivot for spreadsheet 302.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors, system memory, and a display device, the computer system also including a data processing application and a background analysis module, a method for recommending data related to a dataset used within the data processing application, the method comprising:
an act of detecting that a dataset has been accessed within the data processing application as part of performing a specified task; and
subsequent to detecting the dataset has been accessed, and automatically and without user intervention, an act of the background analysis module recommending data to extend the value of the accessed dataset, including:
an act of analyzing one or more of: the accessed dataset, profile information for a user, the specified task, and historical data relevant to the accessed dataset, to identify semantics for locating further data relevant to the accessed dataset;
an act of locating further relevant data from one or more data directories based on the identified semantics; and
an act of presenting a recommendation for further relevant data from each of the one or more data directories at the display device, each recommendation indicating how the further relevant data is relevant to the identified semantics.

2. The method as recited in claim 1, further comprising:
an act of receiving a user selection of a recommendation presented at the display device; and
an act of the background analysis module transferring the further relevant data corresponding to the selected recommendation into the data processing application for use within the data processing application.

3. The method as recite in claim 1, wherein the an act of presenting a recommendation for further relevant data from each of the one or more data directories comprises an act presenting a recommendation for a data directory internal to an organization the user is associated with.

4. The method as recite in claim 1, wherein the an act of presenting a recommendation for further relevant data from each of the one or more data directories comprises an act presenting a recommendation for a data directory external to an organization the user is associated with.

5. The method as recited in claim 1, wherein the act of presenting a recommendation for further relevant data comprises an act of presenting a recommendation for further relevant data that indicates relevancy to the identified semantics based on topic.

6. The method as recited in claim 1, wherein the act of presenting a recommendation for further relevant data comprises an act of presenting a recommendation for further relevant data that extends the understanding of the identified semantics.

7. The method as recited claim 1, wherein the application is selected from among a spreadsheet, a database, a file system, and a word processor.

8. At a computer system including one or more processors, system memory, and a display device, the computer system also including a data processing application and a background analysis module, a method for recommending data related to a dataset used within the data processing application, the method comprising:
an act of detecting that a dataset has been accessed within the data processing application as part of performing a specified task; and
subsequent to detecting the dataset has been accessed, and automatically and without user intervention, an act of the background analysis module recommending a data service to extend the value the of accessed dataset, including:
an act of analyzing one or more of: the accessed dataset, profile information for a user, the specified task, and historical data relevant to the accessed dataset, to identify semantics for locating a data service relevant to the accessed dataset;
an act of locating one or more data services for providing data relevant to the accessed dataset based on the identified semantics; and
an act of presenting a recommendation for the one or more data services at the display device, each recommendation indicating how the data service is relevant to the identified semantics.

9. The method as recited in claim 8, further comprising:
an act of receiving a user selection of a recommendation presented at the display device; and
an act of the background analysis module transferring relevant data from the data service corresponding to the selected recommendation into the data processing application for use within the data processing application.

10. The method as recite in claim 8, wherein the an act of presenting a recommendation for one or more data services comprises an act presenting a recommendation for a data service internal to an organization the user is associated with.

11. The method as recite in claim 8, wherein the an act of presenting a recommendation for one or more data services comprises an act presenting a recommendation for a data service external to an organization the user is associated with.

12. The method as recited in claim 8, wherein the act of presenting a recommendation for one or more data services comprises presenting a recommendation for a data service that indicates relevancy to the identified semantics based on topic.

13. The method as recited in claim 8, wherein the act of presenting a recommendation for one or more data services comprises presenting a recommendation for a data service extends the understanding of the identified semantics.

14. The method as recited claim 6, wherein the application is selected from among a spreadsheet, a database, a file system, and a word processor.

15. A computer system, the computer system comprising:
one or more processors;
system memory;
a display device; and
one or more computer storage devices having stored thereon computer executable instructions representing a background analysis module and a user interface, wherein the background analysis module is configured to:
detect that a user has accessed a dataset within the data processing application as part of performing a specified task; and
subsequent to detecting the dataset has been accessed, and automatically and without user intervention, an act of the background analysis module recommending a data service to extend the value the of accessed dataset, including:
analyze one or more of: the accessed dataset, profile information for the user, the specified task, and historical data relevant to the accessed dataset, to identify semantics for locating a data service relevant to the accessed dataset;
locate any relevant data from one or more data directories based on the identified semantics;
locate any data services for providing relevant data to the accessed dataset based on the identified semantics; and
formulate a recommendation for each of any located further relevant data and for each of any located data services, each recommendation indicating how further relevant data or data service is relevant to the identified semantics; and
wherein the user interface module is configured to:
receive a recommendation for each of any located further relevant data and for each of any located data services;
present recommendations for each of any located further relevant data and for each of any located data services at the display device;
receive a user selection of a recommendation presented at the display device; and
wherein the background analysis module is further configured to:
transfer the further relevant data corresponding to the selected recommendation into the data processing application for use within the data processing application.

16. The computer system as recited in claim 15, wherein the user interface module is configured to present recommendations for each of any located further relevant data and for each of any located data services at the display device comprises the user interface module is configured to present a recommendation for a data service internal to an organization the user is associated with.

17. The computer system as recited in claim 15, wherein the user interface module is configured to present recommendations for each of any located further relevant data and for each of any located data services at the display device comprises the user interface module is configured to present a recommendation for a data service external to an organization the user is associated with.

18. The computer system as recited in claim 15, wherein the user interface module is configured to present recommendations for each of any located further relevant data and for each of any located data services at the display device comprises the user interface module is configured to present a recommendation for a data directory internal to an organization the user is associated with.

19. The computer system as recited in claim 15, wherein the user interface module is configured to present recommendations for each of any located further relevant data and for each of any located data services at the display device comprises the user interface module is configured to present a recommendation for a data directory external to an organization the user is associated with.

20. The computer system as recited in claim 15, wherein the application is selected from among a spreadsheet, a database, a file system, and a word processor.
